(19) United States
(12) Patent Application Publication
(10) Pub. No.: US 2025/0308085 A1
(43) Pub. Date: Oct. 2, 2025

(54) CONTENT GENERATION DEVICE, CONTENT GENERATION METHOD, AND NON-TRANSITORY RECORDING MEDIUM

(71) Applicant: NEC Corporation, Tokyo (JP)

(72) Inventors: Shinnosuke NISHIMOTO, Tokyo (JP); Noriko SAKAI, Tokyo (JP); Yasuhiko YOSHIDA, Tokyo (JP); Yuka ENDO, Tokyo (JP); Hanaka UNO, Tokyo (JP)

(73) Assignee: NEC Corporation, Tokyo (JP)

(21) Appl. No.: 19/063,437

(22) Filed: Feb. 26, 2025

(30) Foreign Application Priority Data
Mar. 29, 2024 (JP) 2024-057606

(51) Int. Cl. G06T 11/00; G06V 20/52

(52) U.S. Cl. CPC G06T 11/00; G06V 20/52

(57) ABSTRACT

Content reflecting road surface data is generated. A content generation device of the present disclosure includes an acquisition unit for acquiring a road surface data indicating a state of a road surface through which a target user passes, and a content generation unit for inputting a prompt including the road surface data to a machine-learned content generation model to generate, by the content generation model, content to be presented to the user passing through the road surface.

This application is based upon and claims the benefit of priority from Japanese Patent Application No. 2024-057606, filed on Mar. 29, 2024, the disclosure of which is incorporated herein in its entirety by reference.

### TECHNICAL FIELD

The present disclosure relates to a content generation device, a content generation method, and a non-transitory recording medium.

### BACKGROUND ART

Reference literature (JP 2019-23770 A) describes a video generation device including a control unit for controls the video generation device, a sensor unit for acquires sensor data, a positioning unit for calculates positioning data of a user wearing the video generation device based on the sensor data, a camera data generation unit for generates camera data including at least one of camera coordinates, a camera orientation, and a camera angle of view in a 3D pseudo space, an avatar data generation unit for generates avatar data including avatar coordinates and avatar motion in the 3D pseudo space and generates avatar coordinates based on the pace data, a 3D video generation unit for generates a 3D pseudo space video based on the camera data and the avatar data, and a video display unit for displays the 3D pseudo space video.

The reference literature focuses on simple use of map data, and there is a problem that information about a road surface cannot be reflected in content.

### SUMMARY

A main object of the present disclosure is to generate content reflecting road surface data.

An aspect of a content generation device includes an acquisition unit for acquiring road surface data indicating a state of a road surface through which a target user passes, and a content generation unit for inputting a prompt including the road surface data to a machine-learned content generation model to generate, by the content generation model, content to be presented to the user passing through the road surface.

An aspect of a content generation method includes an acquisition process of at least one processor acquiring road surface data indicating a state of a road surface through which a target user passes, and a content generation process of at least one processor inputting a prompt including the road surface data to a machine-learned content generation model to generate, by the content generation model, content to be presented to the user passing through the road surface.

An aspect of a non-transitory program recording medium that records a program for causing a computer to function as a content generation device, the program causing the computer to execute a process of acquiring road surface data indicating a state of a road surface through which a target user passes, and a process of inputting a prompt including the road surface data to a machine-learned content generation model to generate, by the content generation model, content to be presented to the user passing through the road surface.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of an overall configuration of a content generation system according to the present disclosure;

FIG. 2 is a diagram illustrating an example of a hardware configuration of the content generation device;

FIG. 3 is a diagram illustrating an example of a block diagram of a content generation device according to the present disclosure;

FIG. 4 is a diagram illustrating an example of data according to the present disclosure;

FIG. 5 is a diagram illustrating a content generation example according to the present disclosure;

FIG. 6 is a diagram illustrating a content output example according to the present disclosure;

FIG. 7 illustrates a flowchart according to the present disclosure;

FIG. 8 is a diagram illustrating an example of a block diagram of a content generation device according to the present disclosure;

FIG. 9 is a diagram illustrating a content generation example according to the present disclosure;

FIG. 10 is a diagram illustrating a content output example according to the present disclosure;

FIG. 11 illustrates a flowchart according to the present disclosure;

FIG. 12 is an example of a block diagram of a content generation device according to the present disclosure; and

FIG. 13 illustrates a flowchart according to the present disclosure.

### EXAMPLE EMBODIMENT

Next, a detailed explanation will be given for a first example embodiment with reference to the drawings.

### First Example Embodiment

Hereinafter, preferred example embodiments of the present disclosure will be described with reference to the drawings.

### Overall Configuration

In the first example embodiment, a content generation system that outputs content reflecting an analysis result of the road surface data will be described.

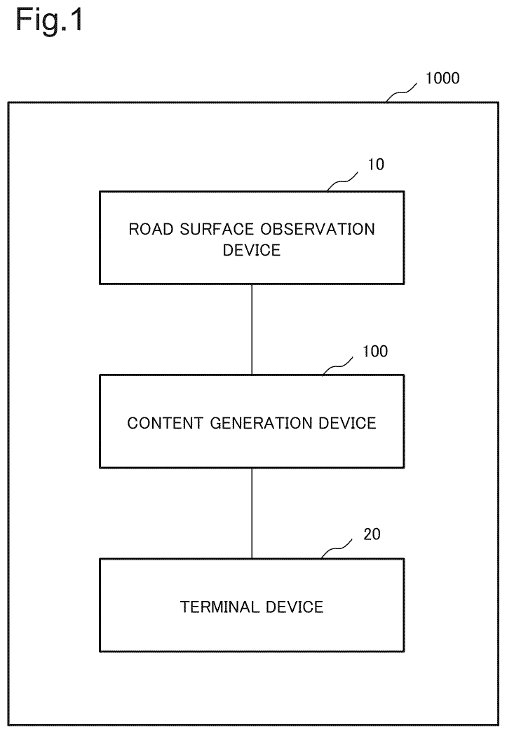

FIG. 1 illustrates an overall configuration of a content generation system 1000 according to the first example embodiment. As an example, the content generation system includes a road surface observation device 10, a terminal device 20, and a content generation device 100.

### Hardware Configuration

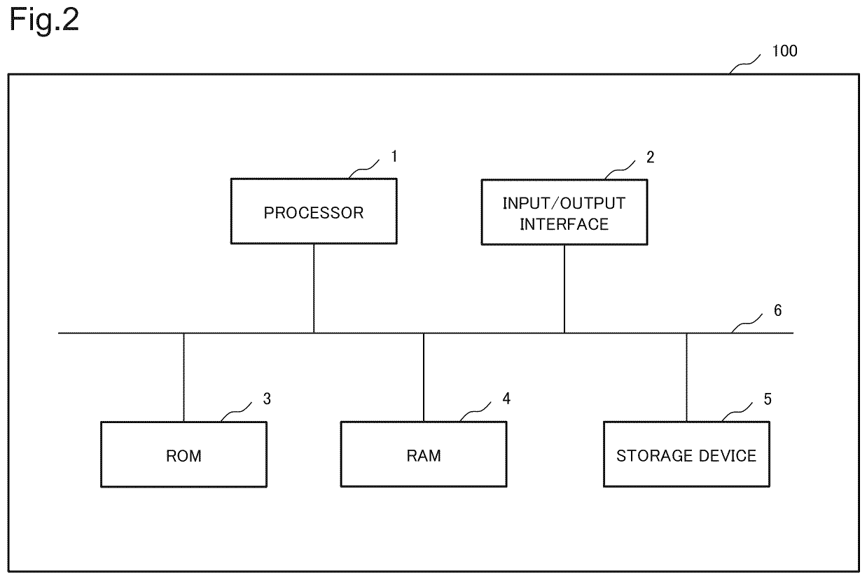

FIG. 2 is a block diagram illustrating a hardware configuration of the content generation device 100. As illustrated, the content generation device 100 includes a processor 1, an input/output interface 2, a read only memory (ROM) 3, a random access memory (RAM) 4, and a storage device 5. The components are connected through, for example, a bus 6.

The processor 1 is a computer such as a central processing unit (CPU), and controls the entire content generation device 100 by executing a program prepared in advance. Specifically, examples of the processor 1 can include a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof.

The processor 1 loads a program stored in the ROM 3, the storage device 5, or the like. Then, the processor 1 executes each process coded in the program. The processor 1 functions as part or all of the content generation device 100. The processor 1 may execute processing or instructions in a flowchart described later based on the program.

The input/output interface 2 is an interface for the content generation device 100 to transmits and receives data to and from another device. For example, the content generation device 100 acquires the road surface data from the road surface observation device 10 via the input/output interface. The content generation device 100 transmits the generated content to the terminal device 20 via the input/output interface 2. The terminal device 20 is a device that transmits and receives data to and from the content generation device 100. For example, the terminal device 20 may be a mobile phone, a smartphone, a tablet terminal, a computer, a wearable device, a head-mounted display, a spatial computer, or the like.

The ROM 3 stores various programs executed by the processor 1. The RAM 4 is used as a working memory during execution of various processes by the processor 1.

The storage device 5 is a non-volatile non-transitory storage device. For example, the storage device 5 may be a disk-shaped non-transitory recording medium, a semiconductor memory, or the like. Storage device 5 may be configured to be detachable from the content generation device 100. The storage device 5 records various programs executed by the processor 1. A machine learning model, learning data, and the like used in a content generation process to be described later may be stored.

### Functional Configuration

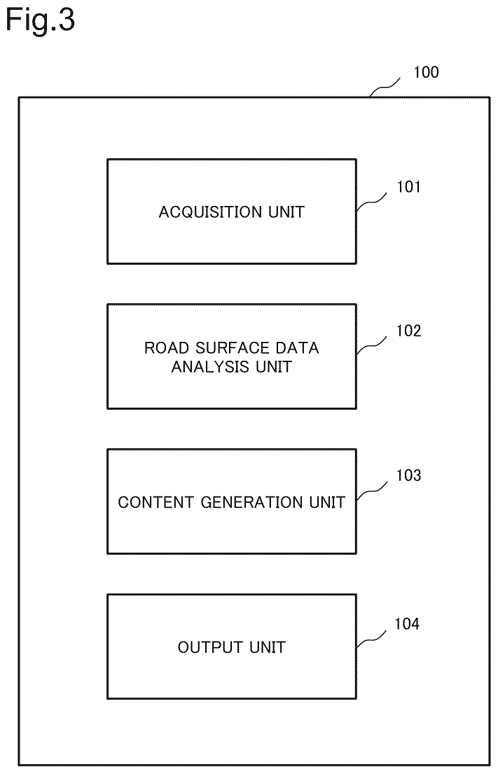

FIG. 3 is a block diagram illustrating a configuration of the content generation device 100. The content generation device 100 functionally includes an acquisition unit 101, a road surface data analysis unit 102, a content generation unit 103, and an output unit 104.

The content generation device 100 can be implemented by a computer. The content generation device 100 can be implemented by, for example, cloud computing. The content generation device 100 can be implemented by, for example, a plurality of computers communicably connected to each other. Each component of the content generation device 100 may be distributed and implemented in a plurality of computers. That is, the computer that implements the acquisition unit 101, the computer that implements the road surface data analysis unit 102, the computer that implements the content generation unit 103, and the computer that implements the output unit 104 May be physically separate. The function of each of the plurality of components may be implemented by a plurality of computers.

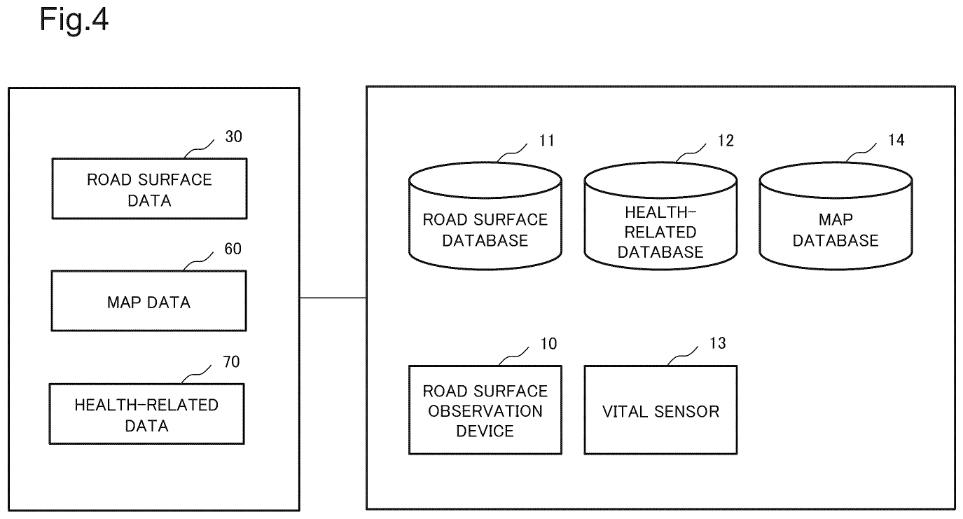

FIG. 4 illustrates data acquired by the acquisition unit 101. Acquisition unit 101 acquires, from the road surface observation device 10, road surface data 30 indicating a state of a road surface through which a user passes. The acquisition unit 101 may acquire at least one of map data 60 and health-related data 70 of the user. Acquisition unit 101 may acquire health-related data 70 via a vital sensor 13. The acquisition unit 101 may acquire the road surface data 30, the map data 60, and the health-related data 70 from the storage device 5. Alternatively, acquisition unit 101 may acquire the road surface data 30 from a database in which the road surface data 30 generated based on the observation result by the road surface observation device 10 is accumulated in advance. The acquisition unit 101 may acquire map data from a database in which the map data 60 is accumulated in advance. The acquisition unit 101 may acquire the health-related data 70 from the health-related database 12 in which the health-related data 70 is accumulated in advance.

In the present disclosure, a road surface means a surface of a passage through which a user can pass. The passage may be a road provided outdoors or may be an indoor passage. The user may pass on foot on a road surface, or pass using an auxiliary instrument such as a wheelchair. The user may pass on a road surface by riding on a moving body that autonomously travels, such as a robot, or a moving body that moves by the user's operation, such as an automobile or a bicycle.

In the present disclosure, road surface observation device 10 is a device that observes a state of a road surface. The road surface observation device 10 may be, for example, an imaging device such as a camera. The road surface observation device 10 may be a detection device such as a sensor. The road surface observation device 10 may include, for example, an RGB camera, a three-dimensional camera such as a depth camera, a three-dimensional laser scanner, or Light Detection and Ranging (LiDAR). The road surface observation device 10 includes a device that measures an inclination of a road surface such as an inertial measurement unit (IMU).

The road surface data is data obtained by observing the road surface using the road surface observation device 10. Since the road surface data is obtained by observing the road surface along the time series, the road surface data is time-series data. That is, the road surface data can be acquired with the lapse of time. For example, the road surface data may be acquired for each observation cycle. For example, the road surface data may be acquired for each sampling period. The format of the road surface data may vary depending on the type of the road surface observation device 10. For example, the road surface data may be an image, a sound, 3D scan data, or the like, or a combination thereof. The “image” may be a moving image or a still image. The same applies to the following description, and when simply described as an “image”, it means either or both of a moving image and a still image. For example, the road surface data recorded in the storage device 5 may be acquired, or the road surface data recorded in an external database via a communication line may be acquired by the acquisition unit 101.

The map data is data representing various features related to a target region (specifically, a region through which a user passes). The map data includes, for example, building information about buildings existing in the region, road information (road width, traffic volume, presence or absence of right turn signal, recommended lane, etc.) about roads existing in the region, road congestion information, destination information designated by the user, information indicating facilities frequently used by the user, and on-map object attribute information. For example, the map data recorded in the storage device 5 may be acquired, or the map data recorded in an external map information database (for example, road traffic information of Japan Road Traffic Information Center (JARTIC: registered trademark), Google Maps Platform, Yahoo Javascript Map, electronic land web, and the like.) via a communication line may be acquired by the acquisition unit 101. The on-map object attribute information is information including position information and attributes of objects on the map. For example, the on-map object attribute information may include information indicating position information and attributes of objects of a traffic light, a road sign, an advertisement signboard, and a commercial facility indicated on the map. The attribute of each object may be appropriately determined. For example, the attribute of the traffic light may be a traffic light device or may be a traffic light as it is.

The health-related data is data related to health of the user. The health-related data may be obtained from a terminal such as a smart watch worn by the user. The health-related data may include a result of the user's medical examination (height, weight, body fat percentage, body age, body mass index (BMI), basal metabolism, visceral fat level, and the like). The health-related data may include weather, temperature, pedometer measurement information (date, number of steps, number of steps per time zone, etc.), sphygmomanometer measurement information (maximum blood pressure, minimum blood pressure, pulse rate, measurement time, etc.), weight measurement information (weight measurement time, etc.), vital data (pulse, respiration, etc.), body temperature, line of sight information, life information (mood, physical condition, meal, exercise, sleep, smoking status, drinking status, etc.), attribute information (nickname, gender, date of birth, age, family structure, and the like of the user), sleep related data (measurement date, actual sleep time, sleeping time, awakening time, hour, and number of times, quality of sleep, number of times of snoring, snoring level, etc.), schedule information about the user, and the like. The health-related data may include intake meal information indicating an intake meal. For example, the intake meal information includes content, calories, and intake time of a meal (breast, lunch, dinner, etc.), a type and an intake amount of a drink, and an intake amount of each nutrient (proteins, carbohydrates, lipids, vitamins, and the like).

Road surface data analysis unit 102 analyzes the road surface data 30 acquired by the acquisition unit 101 using the road surface analysis model. In the present example embodiment, the analysis refers to determining a road surface analysis result based on the road surface data 30, and for example, refers to converting the road surface data 30 as raw data into data that can be interpreted by a human, predicting an unknown event based on the road surface data 30, and the like.

The road surface analysis model is a model obtained by machine learning the relationship between the road surface data and the road surface analysis result, and the output result of the road surface analysis model is a road surface analysis result. The road surface analysis model may be stored in the storage device 5 or the like, for example. The road surface data used for machine learning of the road surface analysis model may be any road surface data collected for any road surface. The road surface data used as the learning data may or may not include road surface data related to a road surface in the region same as that of the road surface data (acquired by the acquisition unit 101) to be analyzed. The road surface analysis result is data obtained by analyzing the road surface data. For example, information such as the presence or absence of foreign matter on the road surface, position information about the foreign matter when there is the foreign matter, an inclination angle of the road surface, an index (such as a friction coefficient) indicating slipperiness of the road surface, an index, of the road surface, indicating ease of walking, and a material of the road surface may be included. The data format of the road surface analysis result may be a numerical value, a character string including a natural language, or the like.

The road surface analysis model may be generated by a known machine learning algorithm (for example, random forest, support vector machine, naïve Bayes, neural network, or the like). The road surface data analysis unit 102 may output a plurality of road surface analysis results using a plurality of output values of the road surface analysis model.

The learning data of the road surface analysis model is data in which an explanatory variable (a feature amount to be described later) serving as an input of the road surface analysis model is associated with an objective variable (a road surface analysis result) serving as an output of the road surface analysis model. For example, the road surface data may be used as an explanatory variable, and the objective variable may be an index indicating an object on the road surface or an index indicating slipperiness of the road surface. Specifically, the data may be created by associating a portion indicating an object on the road surface appearing in the image as an objective variable with an explanatory variable (that is, a feature amount of the image) generated from road surface data that is an image of the road surface or the image, or may be created by associating an index indicating slipperiness of the road surface as an objective variable with an actually measured friction coefficient.

The content generation unit 103 generates content based on the road surface analysis result output by the road surface data analysis unit 102. The content generation unit 103 may generate content based on at least one of the road surface data, the map data, and the health-related data, and a road surface analysis result. A machine learning model can be used to generate content. The detailed operation will be described below.

In the present disclosure, the content may include information related to road surface data. The format of the content generated by the content generation unit 103 is not particularly limited. For example, the above content may be in the form of an image, audio, text, or the like. The content may be in a format in which an image, audio, text, or the like is combined. For example, the content may be an image of a character.

A machine learning model used by the content generation unit 103 will be described. As the machine learning model, a language model, an image generation model, a speech generation model, or the like may be used, or a combination thereof may be used. Each model will be described below.

### Language Model

The language model is a model that learns a relationship between words in a sentence and generates a related character string related to a target character string (prompt) from the target character string. Using a language model that was trained on texts and sentences in various contexts, it is possible to generate a related character string having appropriate content related to the target character string. For example, a case where a language model is used in the question and answer will be described. In this case, the language model receives an input of a question “What country is Japan?” as the target character string, and generates a character string such as “Japan is an island country in the Northern Hemisphere and . . . ” as an answer to the question.

A method of training the language model is not particularly limited, but as an example, the language model may be trained in such a way as to output at least one sentence including an input character string. As a specific example, the language model is a generative pre-training (GPT: registered trademark) model that outputs a sentence including an input character string by predicting a character string having a high probability following the input character string. In addition, for example, a text-to-text transfer transformer (T5), Bidirectional encoder representations from transformers (BERT), a robustly optimized BERT approach (RoBERTa), efficiently learning an encoder that classifies token replacements accurately (ELECTRA), or the like can be used as the language model.

### Image Generation Model

The image generation model learns a relationship between a sentence and an image, and is a model that generates a related image related to a target character string from the target character string (prompt). Using an image generation model in which various sentences and images are learned, it is possible to generate a related image having appropriate content related to the target character string. For example, a case where image generation is performed using an image generation model will be described. In this case, the image generation model receives an input of “output a character supporting a person going up a slope” as the target character string, to output an image of a character or the like supporting the person going up the slope as an answer. As the image generation model, for example, Stable Diffusion, Midjourney (registered trademark), DALL⋅E2, DALL⋅E3, Adobe Firely, Imagen (registered trademark), or the like may be used.

### Sound Generation Model

The sound generation model learns a relationship between a sentence and a sound, and is a model that generates a related sound related to a target character string from the target character string (prompt). Using a sound generation model in which various sentences and sounds are learned, it is possible to generate related sounds having appropriate content related to the target character string. For example, a case where sound generation is performed using a sound generation model will be described. In this case, the sound generation model receives an input of “The slope is 200 meters long. Generate a sound that matches the current atmosphere.”, as the target character string, to generate music as an answer. Sound generation may be performed using a sound generation model, and in this case, the sound generation model receives an input of “The slope is 200 meters long. Try your best.” as the target character string to output a read sound of the target character string as an answer. As the sound generation model, Suno, Stable Audio, Ileven Labs, Cloud Text-to-Speech, or the like may be used.

The creation of the target character string (prompt) in the present example embodiment will be described. The content generation unit 103 creates a prompt to be input to the machine learning model using the road surface analysis result analyzed by the road surface data analysis unit 102. The content generation unit 103 may create a prompt using the road surface data, the map data, and the health-related data. The prompt may be in the form of a natural language. The user can input a prompt through the input/output interface 2, for example.

The content generation unit 103 may generate a prompt by inputting part of various types of information included in the road surface data, the map data, and the health-related data to a template generated in advance. For example, the content generation unit 103 may use a template “Generate {image} of {character A} for a condition of {user health-related data} in {road surface condition}.”. In this case, the content generation unit 103 can generate a prompt by inputting information acquired from a road surface analysis result or the like to a portion of {road surface condition} {user health-related data} {character A} {image}. The template is stored in the storage device 5 or the like. The information to be inserted into the blank of the template may be determined by documenting the road surface data, the map data, and the health-related data acquired by the acquisition unit 101 using an existing technology and extracting a keyword. The information to be inserted into the blank of the template may be determined by the user using the input/output interface 2. The prompt may also be created using a language model. The content generation unit 103 may search for a similar user based on the road surface data, the map data, and the health-related data acquired by the acquisition unit 101, acquire a prompt input by the similar user in the past, and use the same.

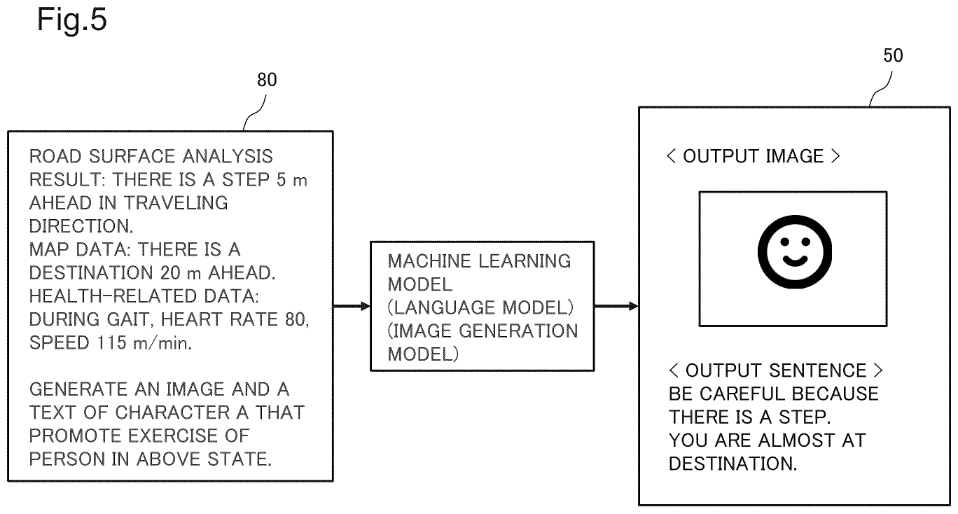

The content generation unit 103 may generate content using a plurality of machine learning models in combination. FIG. 5 illustrates an example in which the content generation unit 103 generates content using a plurality of machine learning models in combination. In the example of FIG. 5, the content generation unit 103 generates a prompt 80 including the road surface data analysis result. The prompt 80 illustrated in FIG. 5 includes sentences indicating the road surface analysis result, the map data, and the health-related data in natural language. Specifically, the prompt 80 illustrated in FIG. 5 reads “Road surface analysis result: There is a step 5 m ahead in the traveling direction. Map data: There is a destination 20 m ahead. Health-related data: during gait, heart rate 80, speed 115 m/min. Generate an image and a text of the character A that promote the exercise of the person in the above state.”.

The content generation unit 103 inputs the prompt 80 to the machine learning model to output an output result of the machine learning model as content 50. For example, in the example of FIG. 5, the content generation unit 103 uses a machine learning model having functions of a language model and an image generation model to generate the content 50 including an image and a sentence. In the content 50 illustrated in FIG. 5, an image of the character A instructed to be generated by the prompt 80, and a sentence, “Be careful because there is a step. You are almost at the destination.” are included corresponding to the road surface analysis result, and the map data.

Specific prompt examples and content generation examples are shown below.

The prompt may include designation of a unique character, person, or object to be output. For example, the content generation unit 103 may generate a prompt including a sentence such as “Generate an animation of the character A that promotes the exercise.”. By inputting such a prompt to the machine-learned content generation model, the content generation unit 103 can generate content including “an animation in which the character A performs an operation of encouraging the user to exercise”.

The prompt may include information indicating the health condition of the user. For example, the content generation unit 103 may generate a prompt including a sentence such as “This user's body fat percentage exceeds the reference value, and a doctor advises that the regular exercise is necessary. Generate a sentence that prompts the user to exercise.”. By inputting this prompt to the machine learning model, the content generation unit 103 can generate content including a sentence of “You are recommended to run about 2 or 3 times a week. Would you like to run a little from now?”.

The prompt may include data about the user's schedule. For example, the content generation unit 103 may generate a prompt including a sentence such as “This user has no schedule for 2 hours from now, and then this user has a schedule of going to a hair salon. Generate a text and an image for this user.”. By inputting this prompt to the machine learning model, the content generation unit 103 may generate content includes a sentence of “You have a reservation for the hair salon in 2 hours. What hairstyle would you like?” and “images of the character in various hairstyles”.

The prompt may include line of sight information indicating a target to which the user's line of sight is directed. For example, the content generation unit 103 may generate a prompt including a sentence such as “The user who is on dietary restrictions is directing his/her line of sight toward a cake shop. Generate an image that prompts dietary restrictions.”. By inputting this prompt to the machine learning model, the content generation unit 103 can generate content including, for example, “an image of a character performing an operation of attracting attention in a direction other than that of a cake shop”.

The prompt may include information about various objects in the user's field of view. For example, the content generation unit 103 may generate a prompt including a sentence such as “There is a traffic light near the user. Output an animation of a character hanging on a traffic light.”. The content generation unit 103 can also generate content including, for example, “an animation of a character hanging on a traffic light” by inputting this prompt to the machine learning model.

The prompt may be a combination of the above examples.

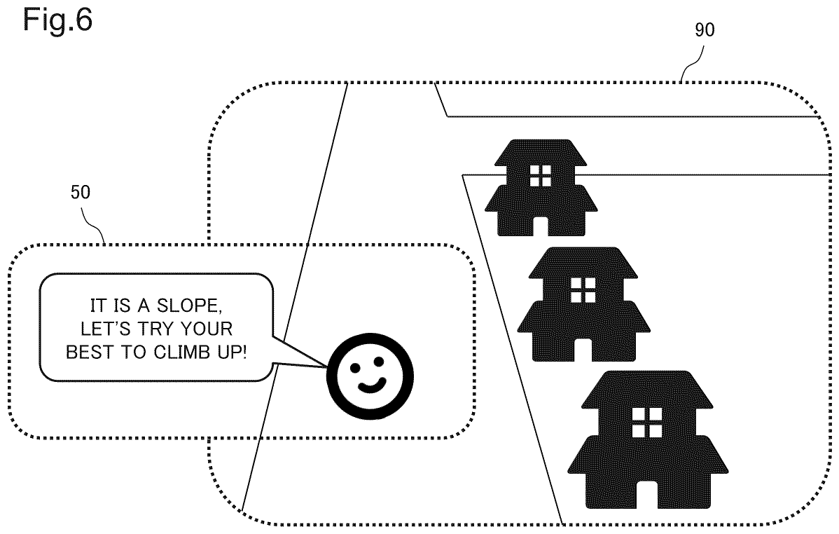

The output unit 104 causes the terminal device 20 (user terminal) to output the content generated by the content generation unit 103. FIG. 6 illustrates an output example of the terminal device 20 according to the first example embodiment. As illustrated in FIG. 6, the content 50 includes a text and an image. The output unit 104 may display the text by associating a balloon in which the text is disposed with a character as illustrated in FIG. 6. As a result, it is possible to have a form in which a character utters a message described in the text. For example, as illustrated in FIG. 6, the output unit 104 may display the image of the character to be superimposed on an image 90 in the view direction of the user acquired from the input/output interface 2, the terminal device 20, the road surface observation device 10, or the like. In this case, the transmission processing may be performed on the background of the character peripheral portion. The output unit 104 may output the content 50 in such a way as to follow the motion (eye line direction, traveling direction, and the like) of the user acquired via an acceleration sensor, a gyro sensor, or the like included in the terminal device 20 or the like. The output unit 104 may output the content 50 in other forms without being limited to the above form, or may output the content by combining a plurality of forms. For example, the output unit 104 may output the text in the form of a sound via reading aloud software or the like.

### Information Process

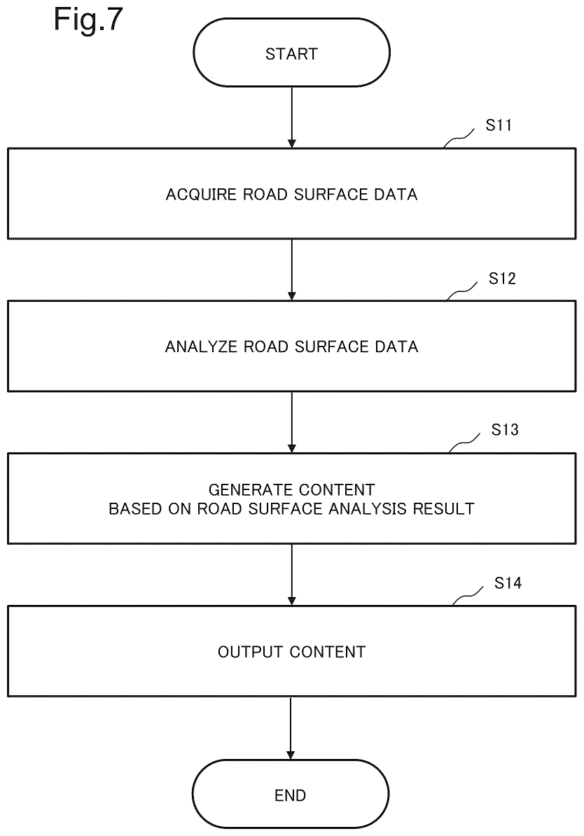

FIG. 7 is a flowchart of processing by the content generation device 100 according to the first example embodiment. This process is implemented by the processor 1 illustrated in FIG. 2 executing a program prepared in advance and operating as respective elements illustrated in FIG. 3. Therefore, the flowchart of FIG. 7 illustrates a content generation method and a content generation program.

First, acquisition unit 101 acquires road surface data (step S11). Next, the road surface data analysis unit 102 analyzes the road surface data acquired in S11 using a road surface analysis model obtained by machine learning the relationship between the road surface data and the road surface analysis result (step S12). Next, the content generation unit 103 generates content based on the road surface analysis result that is the result of the analysis in S12 (step S13). Next, the output unit 104 causes the terminal device 20 to output the content (step S14). This is the end of the process.

As described above, in the first example embodiment, the content reflecting the analysis result of the road surface data can be output.

### Second Example Embodiment

Next, the second example embodiment of the present disclosure will be described. The second example embodiment is different from the first example embodiment in the following points. The content generation device 100 of the second example embodiment includes a route generation unit 105 that generates a route to be recommended to the user, and the output unit 104 further outputs route information in addition to the content. An overall configuration of a content generation system 1000 of the second example embodiment and a hardware configuration illustrated in FIG. 2 are similar to those of the first example embodiment, and thus, description thereof is omitted.

### Functional Configuration

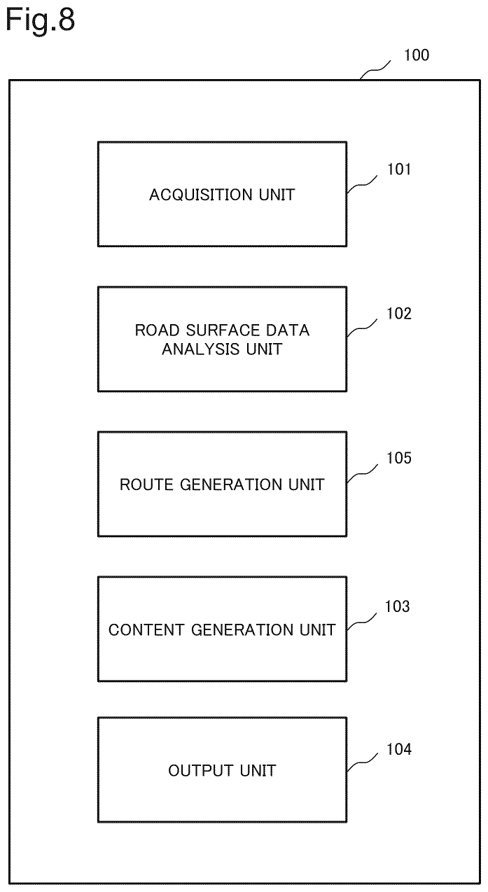

FIG. 8 is a block diagram illustrating a functional configuration of the content generation device 100. As illustrated, the content generation device 100 of the second example embodiment includes an acquisition unit 101, a road surface data analysis unit 102, the route generation unit 105, a content generation unit 103, and an output unit 104. The acquisition unit 101 and the road surface data analysis unit 102 are similar to those of the first example embodiment, and thus, description thereof is omitted.

The route generation unit 105 generates a recommended route for the user based on a mathematical optimization calculation method using a constraint condition for the road surface analysis result. The route generation unit 105 may use at least one of the map data, the road surface data, and the health-related data as a constraint condition.

The mathematical optimization calculation method is a method of defining a certain problem as a mathematical expression and obtaining a value of a variable that minimizes or maximizes an objective function while satisfying a constraint condition. For example, known algorithms may be used, such as dynamic programming, a greedy method, an approximate algorithm, and the like.

First, the route generation unit 105 acquires the map data and the constraint condition. The map data may include, for example, building information about buildings existing in the region, road information (road width, traffic volume, presence or absence of right turn signal, recommended lane, etc.) about roads existing in the region, road congestion information, destination information designated by the user, information indicating facilities frequently used by the user, and on-map object attribute information.

The constraint condition is a condition that the recommended route has to satisfy, and a constraint condition for at least one of the map data, the road surface analysis result, and the health-related data is used. For example, the above constraint condition may include a condition that “the route is constituted by a road having no anomaly in the road surface” and “the route goes through a slope”. The constraint condition may be set or changed by the user.

Next, the route generation unit 105 generates an objective function or acquires an objective function prepared in advance from the storage device 5 or the like. The objective function is a function to be maximized or minimized in the mathematical optimization calculation method. The evaluation items included in the objective function are, for example, “a route distance”, “a required time”, “an inclination of the route”, “an anomaly of the road surface”, and the like. A weight value may be set for each evaluation item. The evaluation item and the weight value may be set or changed by the user. The user may be allowed to designate the arrival/departure point of the route generated by the route generation unit 105. The route generation unit 105 may update the recommended route according to a change in the current position of the user.

After the recommended route is presented to the user, the route generation unit 105 may use feedback information about the recommended route received from the user as a constraint condition or reflect the feedback information in the weight of the objective function to generate a different recommended route. For example, when inputting feedback information indicating that the user does not pass a route without a sidewalk to the route generation model, the route generation unit 105 adds that the user does not pass a route without a sidewalk to the constraint condition and regenerates the recommended route. For example, when inputting feedback information indicating that the user avoids a road with a foreign substance as much as possible, the route generation unit 105 adjusts the coefficient of the term regarding the presence or absence of the foreign substance in the road surface data included in the objective function, and regenerates the recommended route.

The content generation unit 103 generates content based on a road surface analysis result which is a result analyzed by the road surface data analysis unit 102 and the recommended route. The content may be generated based on the road surface data, the map data, and the health-related data. As in the first example embodiment, a machine learning model can be used to generate content, and the machine learning model may use a language model, an image generation model, a sound generation model, or the like, or may be a combination thereof.

The creation of the target character string (prompt) in the present example embodiment will be described. The content generation unit 103 creates a prompt to be input to the machine learning model using the road surface analysis result analyzed by the road surface data analysis unit 102 and the recommended route. The content generation unit 103 may create a prompt using the road surface data, the map data, and the health-related data. The prompt 80 may be in the form of a natural language. The user can input a prompt through the input/output interface 2, for example.

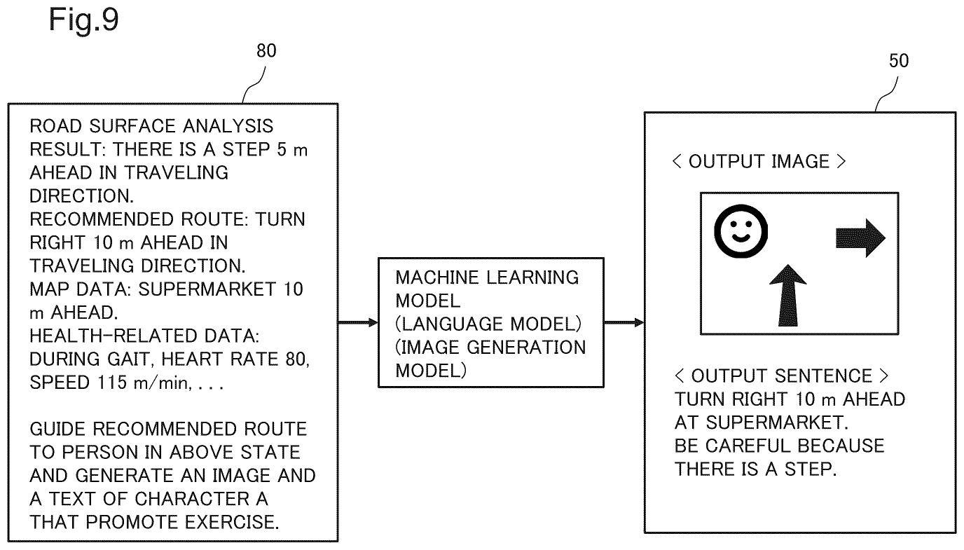

The content generation unit 103 may generate content using a plurality of machine learning models in combination. FIG. 9 illustrates an example in which the content generation unit 103 generates content using a plurality of machine learning models in combination. First, the content generation unit 103 creates the prompt 80 including the road surface analysis result and the recommended route. The prompt 80 illustrated in FIG. 9 includes sentences indicating the road surface analysis result, the recommended route, the map data, and the health-related data in natural language.

The content generation unit 103 inputs the prompt 80 to the machine learning model to output the content. For example, in the example of FIG. 9, the content generation unit 103 uses a machine learning model having functions of a language model and an image generation model, to output the content 50 including an image and a sentence. Specifically, the content 50 illustrated in FIG. 9 includes an image including a character generated by a machine learning model and an arrow indicating a recommended route. The content 50 illustrated in FIG. 9 includes a sentence for describing the recommended route and a sentence for calling the user's attention based on the road surface analysis result.

The content generation unit 103 may generate the content based on the content generation rule base without using the machine learning model. The content generation rule base stores a rule of generating certain content when the recommended route satisfies a certain condition as a road surface analysis result. For example, the content generation rule base may store a rule associated with “generating an image of the character A indicating a direction to turn with a finger” in a case where “the recommended route indicates that the road will turn in 30 m more”. A content generation rule based on the road surface analysis result, the road surface data, the map data, the health-related data, and the on-map object attribute information is as described in the first example embodiment. The rule condition may be a combination of a plurality of conditions.

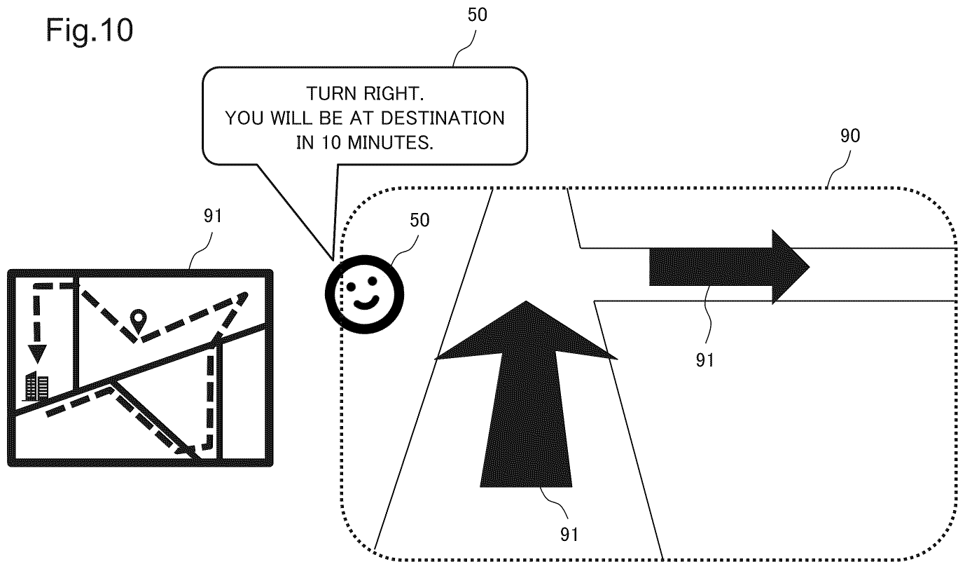

The output unit 104 causes the terminal device 20 to output the content generated by the content generation unit 103 and the recommended route. FIG. 10 illustrates an example of an output to the terminal device 20 according to the first example embodiment. Specifically, FIG. 10 illustrates a recommended route 91 and content 50 that the content generation unit 103 causes the terminal device 20 to output. As illustrated in FIG. 10, the output unit 104 may cause the terminal device to display the recommended route 91 on which information indicating a recommended route (a dashed arrow in the example of FIG. 9) is superimposed on a map. The recommended route may be displayed by an expression method other than this.

As illustrated in FIG. 10, the output unit 104 may superimpose and display the content 50 and the recommended route 91 on an image 90 in the view direction of the user acquired from the terminal device 20, the road surface observation device 10, or the like. In this case, the output unit 104 preferably detects a road portion in the image 90 to output the content 50 and the recommended route 91 in such a way as to conform to the road portion. The output unit 104 may output the content 50 in other forms without being limited to the above forms, or may output the content by combining a plurality of forms. The content is not limited to the above, and may be output in other forms, or may be output in combination of a plurality of forms.

### Information Process

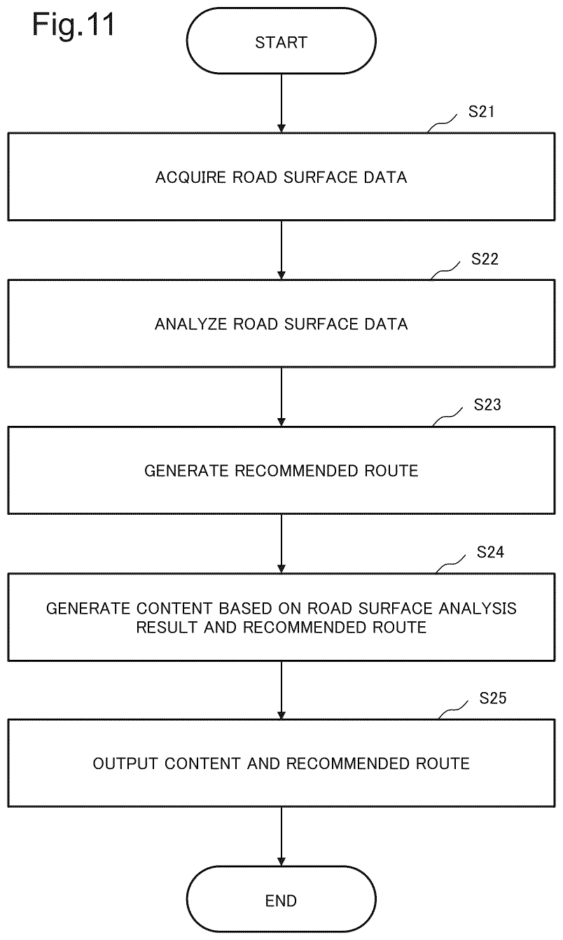

FIG. 11 is a flowchart of processing by the content generation device 100 according to the second example embodiment. This process is implemented by the processor 1 illustrated in FIG. 2 executing a program prepared in advance and operating as respective elements illustrated in FIG. 8.

First, acquisition unit 101 acquires road surface data (step S21). Next, the road surface data analysis unit 102 analyzes the road surface data acquired in S21 using a road surface analysis model obtained by machine learning the relationship between the road surface data and the road surface analysis result (step S22). Next, the route generation unit 105 generates a recommended route for the user based on a mathematical optimization method using a constraint condition on at least one of the map data, the road surface analysis result, and the health-related data (step S23). Next, the content generation unit 103 generates content based on the road surface analysis result that is the result of the analysis in S22 (step S24). Next, the output unit 104 causes the terminal device 20 to output the content (step S25). This is the end of the process.

As described above, in the second example embodiment, the content reflecting the analysis result of the road surface data and the recommended route for the user can be output.

### Third Example Embodiment

Next, the third example embodiment of the present disclosure will be described. The third example embodiment is different from the first example embodiment in the following points. The content generation device 100 of the third example embodiment includes a determination unit 106 in addition to each unit included in the content generation device 100 of the first example embodiment. An overall configuration of a content generation system 1000 of the third example embodiment and a hardware configuration illustrated in FIG. 2 are similar to those of the first example embodiment, and thus, description thereof is omitted.

### Functional Configuration

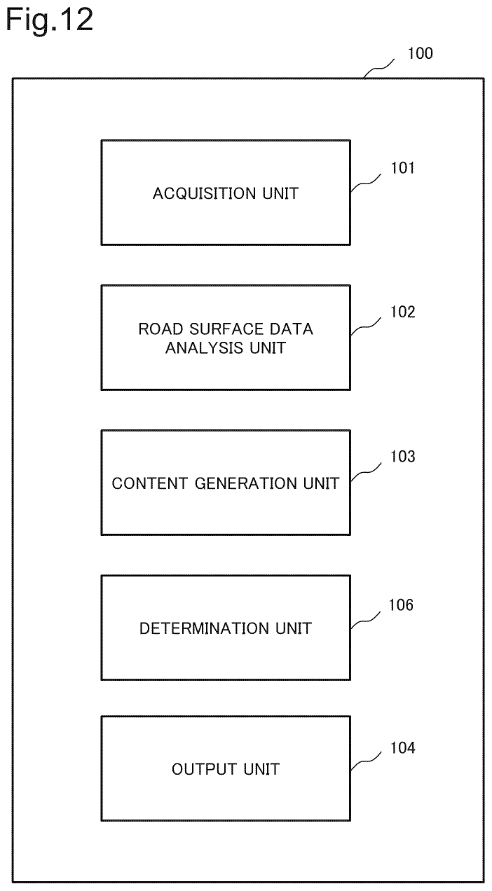

FIG. 12 is a block diagram illustrating a functional configuration of the content generation device 100. As illustrated, the content generation device 100 of the third example embodiment includes an acquisition unit 101, a road surface data analysis unit 102, a content generation unit 103, the determination unit 106, and an output unit 104. The acquisition unit 101 and the road surface data analysis unit 102 are similar to those of the first example embodiment, and thus, description thereof is omitted.

Whether the content generated by the content generation unit 103 satisfies a predetermined condition is determined using a determination model. The determination unit 106 may calculate an evaluation index for content. In this case, the determination unit 106 may determine whether to output the content to the user based on the calculated evaluation index. The evaluation index regarding the content may be an index regarding the accuracy of the content, the ethics of the content, the fairness of the content, the meta information, and the like. As a method of calculating the evaluation index, any method can be applied, and for example, a method using a machine learning model may be used. The evaluation index may be represented by a numerical value. For example, the determination unit 106 may calculate a numerical value between “0 to 10” according to a degree to which the content is appropriate to be presented to the user. In this case, the determination unit 106 may determine to output the content in a case where the calculated evaluation index is the reference value or more, and may determine not to output the content in a case where the calculated evaluation index is less than the reference value. The reference value may be predetermined or may be determined by the user. The determination unit 106 may calculate an evaluation index (for example, 1 if appropriate, 0 if not appropriate) indicating whether the content is appropriate to be presented to the user.

The determination unit 106 may calculate a plurality of indexes, integrate the plurality of indexes, and determine whether to output content, or may combine the plurality of indexes to calculate an evaluation index, and make determination using the evaluation index. The determination unit 106 may make determination using a determination model obtained by machine learning the relationship between the content and whether to output the content. The determination unit 106 may make the determination for respective elements included in the content (for example, sentences, images, sounds, and the like).

As an example, an example in which the determination unit 106 evaluates content using a machine learning model will be described.

For example, determination unit 106 may perform the evaluation from a viewpoint of whether the element included in the content conforms to a predetermined rule. A company that performs character business may define a rule book for each character. The rule book is an aggregate of codes of behavior and guidelines related to a target character defined by a company that performs character business. In the rule book, the character's personality, action pattern, way of speaking, target age group, restrictions for maintaining the quality, and the like are described in detail. The rule book provides guidance on how the character should or should not behave in certain situations. For example, in the case of a character for children, norms such as avoiding violent behavior and inappropriate wording, conveying a positive message, giving priority to content including educational value, and the like are provided.

Determination unit 106 calculates a distance (an example of the above-described “evaluation index”, and can also be referred to as a degree of conformity to the rule) between the generated content and the rules defined in the rule book using the machine learning model. Determination unit 106 can evaluate the content by determining whether the calculated distance is equal to or less than a predetermined threshold value.

The determination unit 106 may evaluate the content based on the fairness of the content. The fairness of the content is an index indicating bias of contribution of a specific feature amount to the content. At this time, as the specific feature amount for which the fairness index is calculated, there is a feature amount that can contribute to fairness, such as gender and race.

The output unit 104 causes the terminal device 20 to output the content determined by the determination unit 106 to be allowed to be output. In a case where it is determined that the content is not allowed to be output, the output unit 104 may output the content to an external server or the like. In a case where the content generated by the content generation unit 103 includes a plurality of pieces of content and the determination unit 106 determines whether to output each of the plurality of pieces of content, the output unit 104 may cause the terminal device 20 to output part of the content determined to be allowed to be output. The content output form is the same as the content described in the first example embodiment and the second example embodiment.

### Information Process

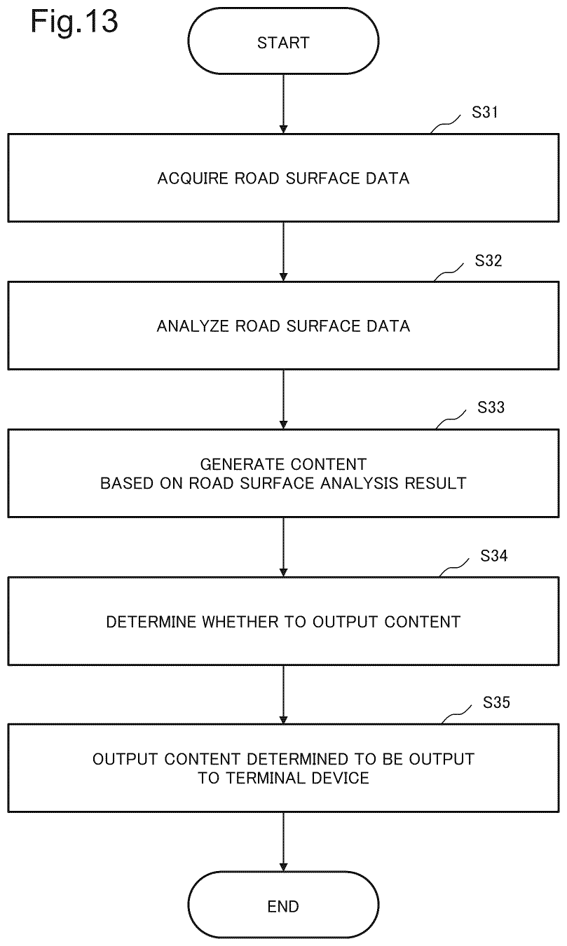

FIG. 13 is a flowchart of processing by the content generation device 100 according to the third example embodiment. This process is implemented by the processor 1 illustrated in FIG. 2 executing a program prepared in advance and operating as respective elements illustrated in FIG. 11.

First, acquisition unit 101 acquires road surface data (step S31). Next, the road surface data analysis unit 102 analyzes the road surface data acquired in S21 using a road surface analysis model that machine learned the relationship between the road surface data and the road surface analysis result (step S32). Next, the content generation unit 103 generates content based on the road surface analysis result that is the result of the analysis in S22 (step S33). Next, the determination unit 106 calculates an evaluation index regarding the content, and determines whether to output the content to the user based on the calculated evaluation index. (step S34). Next, the output unit outputs the content 50 to the terminal device 20 (step S35). This is the end of the process.

As described above, in the third example embodiment, content suitable for output to the user can be output.

While the present disclosure has been particularly shown and described with reference to example embodiments thereof, the present disclosure is not limited to the above example embodiments. Various modifications that can be understood by those of ordinary skill in the art can be made to the configuration and details of the present disclosure within the scope of the present disclosure. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content. The processing of each step illustrated in each flowchart can be executed by one processor, or can be executed by a plurality of processors in a shared manner. That is, the execution subject of the information processing method according to each of the above-described example embodiments may be one processor or a plurality of processors.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

### SUPPLEMENTARY NOTE

Part or all of each example embodiment described above can also be described as the following Supplementary Notes. However, the present disclosure exemplarily described by the above-described example embodiments is not limited to the following.

### Supplementary Note 1

A content generation device including
an acquisition unit for acquiring road surface data indicating a state of a road surface through which a target user passes, and
a content generation unit for inputting a prompt including the road surface data to a machine-learned content generation model to generate, by the content generation model, content to be presented to the user passing through the road surface.

### Supplementary Note 2

The content generation device according to Supplementary Note 1, wherein
the acquisition unit
acquires at least one of map data and health-related data of the user, and the road surface data, and
the content generation unit
generates content based on at least one of the map data and the health-related data of the user and the road surface data.

### Supplementary Note 3

The content generation device according to Supplementary Note 1 or 2, further including
a road surface data analysis unit for analyzing the road surface data using a machine learning model, wherein
the content generation unit
inputs a prompt including at least part of an analysis result of the road surface data to the content generation model to generate content by the content generation model.

### Supplementary Note 4

The content generation device according to Supplementary Note 2, wherein
the content generation unit
inputs a prompt including attribute information about an on-map object included in the map data to the content generation model to generate content by the content generation model.

### Supplementary Note 5

The content generation device according to Supplementary Note 3, further including
a route generation unit for generating a recommended route for the user based on an analysis result of the road surface data, wherein
the content generation unit inputs the analysis result of the road surface data and the recommended route to the content generation model to generate the content by the content generation model.

### Supplementary Note 6

The content generation device according to Supplementary Note 5, wherein
the content generation device generates the recommended route to the user by mathematical optimization calculation using a constraint condition on the analysis result of the road surface data.

### Supplementary Note 7

The content generation device according to Supplementary Note 6, wherein
the route generation unit inputs feedback information about the recommended route from a user to a route generation model to generate a route different from the recommended route by the route generation model.

### Supplementary Note 8

The content generation device according to any one of Supplementary Notes 1 and 2, further including
a determination unit for determining whether the content satisfies a predetermined condition using a determination model that machine learned a relationship between content and whether to output the content, and
an output unit for outputting the content, wherein
the output unit
outputs the content to a user terminal in a case where the determination unit determines that the content is allowed to be output.

### Supplementary Note 9

A content generation method including
an acquisition process of at least one processor acquiring road surface data indicating a state of a road surface through which a target user passes, and
a content generation process of at least one processor inputting a prompt including the road surface data to a machine-learned content generation model to generate, by the content generation model, content to be presented to the user passing through the road surface.

### Supplementary Note 10

A content generation program for causing a computer to function as a content generation device,
the program causing the computer to function as
an acquisition unit for acquiring road surface data indicating a state of a road surface through which a target user passes, and
a content generation unit for inputting a prompt including the road surface data to a machine-learned content generation model to generate, by the content generation model, content to be presented to the user passing through the road surface.

Some or all of the configurations described in the Supplementary Note 2 to 8 dependent on the Supplementary Note 1 described above can also depend on the Supplementary Notes 9 and 10 in the same dependency relationship as the Supplementary Notes 2 to 8. Furthermore, some or all of the configurations described as the Supplementary Notes can be similarly dependent on not only the Supplementary Notes 1, 9, and 10, but also various pieces of hardware and software, and various recording means or systems for recording software without departing from the above-described example embodiments.

1. A content generation device comprising:
one or more memories storing instructions; and
one or more processors configured to execute the instructions to:
acquire a road surface data indicating a state of a road surface through which a target user passes; and
input a prompt including the road surface data to a machine-learned content generation model to generate, by the content generation model, content to be presented to the user passing through the road surface.

2. The content generation device according to claim 1, wherein
the one or more processors are further configured to execute the instructions to:
acquire the road surface data and at least one of map data and health-related data of the user, and
generate content based on the road surface data and at least one of the map data and the health-related data of the user.

3. The content generation device according to claim 1, wherein
the one or more processors are further configured to execute the instructions to:
analyze the road surface data using a road surface analysis model obtained by machine learning; and
input a prompt including at least part of an analysis result of the road surface data to the content generation model to generate content by the content generation model.

4. The content generation device according to claim 2, wherein
the one or more processors are further configured to execute the instruction to:
input a prompt including attribute information about an on-map object included in the map data to the content generation model to generate content by the content generation model.

5. The content generation device according to claim 3, wherein
the one or more processors are further configured to execute the instructions to:
generate a recommended route for the user based on an analysis result of the road surface data; and
input the analysis result of the road surface data and the recommended route to the content generation model to generate the content by the content generation model.

6. The content generation device according to claim 5, wherein the one or more processors are configured to further execute the instruction to: generate the recommended route to the user by mathematical optimization calculation using a constraint condition on the analysis result of the road surface data.

7. The content generation device according to claim 6, wherein the one or more processors are configured to further execute the instruction to: input feedback information about the recommended route from a user to a route generation model to generate, by the route generation model, a route different from the recommended route.

8. The content generation device according to claim 1, wherein
the one or more processors are further configured to execute the instructions to:
determine whether the content satisfies a predetermined condition using a determination model that machine learned a relationship between content and whether to output the content; and
output the content to a user terminal in a case where the determination unit determines that the content is allowed to be output.

9. A content generation method, comprising:
by a computer,
acquiring a road surface data indicating a state of a road surface through which a target user passes; and
inputting a prompt including the road surface data to a machine-learned content generation model to generate, by the content generation model, content to be presented to the user passing through the road surface.

10. A non-transitory recording medium that records a program for causing a computer to function as a content generation device, the program causing the computer to execute:
acquiring a road surface data indicating a state of a road surface through which a target user passes; and
inputting a prompt including the road surface data to a machine-learned content generation model to generate, by the content generation model, content to be presented to the user passing through the road surface.
